(19) United States
(12) Patent Application Publication
(10) Pub. No.: US 2006/0236015 A1
(43) Pub. Date: Oct. 19, 2006

(54) Information processing apparatus and operation control method

(76) Inventor: Hiroyuki Tsuji, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/397,126

(22) Filed: Apr. 4, 2006

(30) Foreign Application Priority Data
Apr. 18, 2005 (JP) 2005-119578

(51) Int. Cl. G06F 13/00

(52) U.S. Cl. 710/303

(57) ABSTRACT

According to one embodiment, an information processing apparatus includes a main body to which an external device is connectable, a detection unit configured to detect that a switch arranged on the external device is operated, and a control unit configured to execute a device removing process for setting a system of the main body to a state wherein the external device can be removed from the main body, when the detection unit detects that the switch is operated.

### CROSS-REFERENCE TO RELATED APPLICATIONS

This application is based upon and claims the benefit of priority from Japanese Patent Application No. 2005-119578, filed Apr. 18, 2005, the entire contents of which are incorporated herein by reference.

### BACKGROUND

1. Field

One embodiment of the invention relates to an information processing apparatus including a main body to which an external device can be connected, and an operation control method used in the apparatus.

2. Description of the Related Art

In recent years, various portable information processing apparatuses, such as notebook personal computers, have been developed. An external device can be connected to such information processing apparatus to expand the functions of the information processing apparatus, as needed.

Jpn. Pat. Appln. KOKAI Publication No. 8-179856 discloses a system for controlling docking/undocking between a portable computer and a host station. This system has a function of preventing the flow of a large rush current at the time of docking/undocking.

Recently, an external device which supports a hot plug/hot unplug function has been developed. As typical examples of the external device which supports the hot plug/hot unplug function, a universal serial bus (USB) device having a USB interface, an IEEE1394 device having an IEEE1394 interface, and a device having a serial advanced technology attachment (SATA) interface are known.

The device which supports the hot plug/hot unplug function can be connected/removed to/from the information processing apparatus which is powered on.

However, actually, when a user removes an external device from the information processing apparatus while the external device is being accessed, data transferred between the external device and the information processing apparatus may be lost, or the external device itself may break, thus posing a problem.

To cope with this problem, an operating system generally has a function for safely removing the external device. However, in order to activate this function, the user must select and click a specific icon displayed on the task tray of a display screen. The user must also select, from a menu window on which an external device list is displayed, the external device to be removed. The operation is complex, and a relatively long period of time is required until the external device can be actually safely removed.

Therefore, the external device is required to be removed quickly by a simple operation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus and an external device according to an embodiment of the present invention;

FIG. 2 is an exemplary perspective view showing a state wherein the information processing apparatus and external device shown in FIG. 1 are connected;

FIG. 3 is a block diagram showing an example of the system arrangement of the information processing apparatus shown in FIG. 1;

FIG. 4 is a block diagram showing an example of the system arrangement of the external device shown in FIG. 1;

FIG. 5 is a flowchart showing an example of the process of removing the external device from the information processing apparatus, which is executed by the information processing apparatus shown in FIG. 1;

FIG. 6 is a flowchart showing the first example of a safety removing process executed by the information processing apparatus shown in FIG. 1;

FIG. 7 is a flowchart showing the second example of the safety removing process executed by the information processing apparatus shown in FIG. 1;

FIG. 8 is a view for explaining a display example of a removing icon displayed by the information processing apparatus shown in FIG. 1;

FIG. 9 is a flowchart for explaining an example of a removing process executed upon operation of the removing icon displayed on the display screen shown in FIG. 8; and

FIG. 10 is an exemplary perspective view showing the outer appearance of an information processing apparatus according to another embodiment of the present invention.

### DETAILED DESCRIPTION

Various embodiments according to the invention will be described hereinafter with reference to the accompanying drawings. In general, according to one embodiment of the invention, an information processing apparatus includes a main body to which an external device is connectable, a detection unit configured to detect that a switch arranged on the external device is operated, and a control unit configured to execute a device removing process for setting a system of the main body to a state wherein the external device can be removed from the main body, when the detection unit detects that the switch is operated.

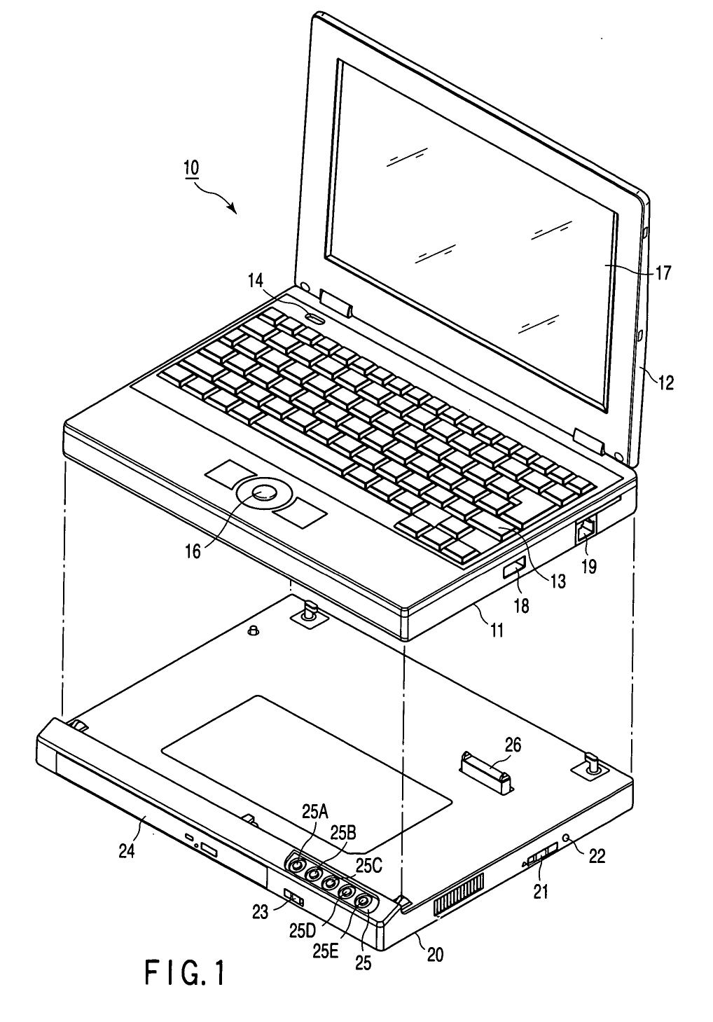

Referring to FIGS. 1 to 3, the arrangement of an information processing apparatus according to an embodiment of the present invention will be described below. This information processing apparatus serves as a battery drivable and portable notebook personal computer 10. A docking station 20 can be connected as an external device to the notebook personal computer 10. The docking station 20 functions as an expansion unit for expanding the functions of the computer 10.

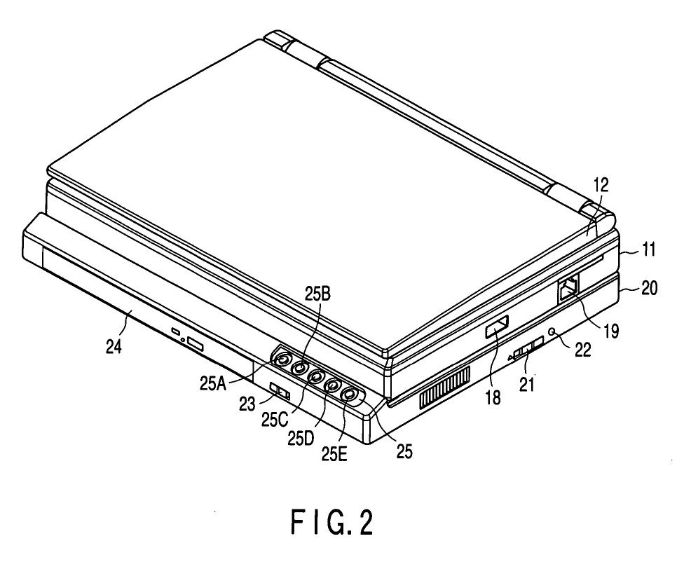

FIG. 1 is an exemplary perspective view showing the outer appearances of the computer 10 and the docking station 20. In FIG. 2, the computer 10 is connected to the docking station 20.

The computer 10 comprises a computer main body 11 and display unit 12. The display unit 12 incorporates a display device comprising a liquid crystal display (LCD) 17. The display screen of the LCD 17 is located at nearly the center of the display unit 12.

The display unit 12 is supported by the computer main body 11, and is attached to the computer main body 11 to be pivotal between an open position where the top surface of the computer main body 11 is exposed and a closed position where the display unit 12 covers the top surface of the computer main body 11. The computer main body 11 has a low-profile box-shaped housing. On the top surface of the computer main body 11, a keyboard 13, a power button switch 14 used to turn on/off the power supply of the computer 10, a pointing device 16, and the like are arranged.

On the side wall of the computer main body 11, a USB port 18, local area network (LAN) port 19, and the like are formed. The USB port 18 is a connector used to connect a USB compatible device. The LAN port 19 is a connector used to connect a LAN cable.

For example, the docking station 20 functions as an external USB device. The docking station 20 has a low-profile box-shaped housing. In the housing of the docking station 20, an optical disc drive 24 is accommodated. The optical disc drive 24 is a drive unit used to drive a storage medium such as a digital versatile disc (DVD) and compact disc (CD) in which audio/video contents and the like are stored.

The top surface of the housing of the docking station 20 functions as a mount space for mounting the computer main body 11. On the mount space, a docking interface connector 26 is arranged. When the computer main body 11 is placed on the mount space, the docking interface connector 26 is connected to a docking interface connector on the bottom surface of the computer main body 11. The computer 10 then identifies the docking station 20 (more specifically, the optical disc drive 24) as an external USB device, and adds the docking station 20 to the hardware resource of the computer 10 (docking process).

The housing of the docking station 20 also includes an undocking switch 21, light emitting diode (LED) 22, hold switch 23, and input operation panel 25.

The undocking switch 21 is an operation switch which issues a request to remove the docking station 20 from the computer 10. When the user operates the undocking switch 21, the computer 10 executes a device removing process (undocking process) for setting the system of the computer main body 11 to a state wherein the docking station 20 can be removed from the computer main body 11. Upon execution of this device removing process, the docking station 20 is removed from the hardware resources of the computer 10.

The LED 22 is an indicator for indicating the connection state between the computer 10 and the docking station 20. When the computer 10 and the docking station 20 are connected, more specifically, during a period in which the computer 10 and the docking station 20 are in the docking state, the LED 22 is ON. During the device removing process, the LED 22 is OFF.

The input operation panel 25 serves as an input unit for inputting an event corresponding to the pressed button switch, and has a plurality of button switches used to activate the respective functions. The button switch group includes a DVD/CD start button switch 25A, playback/pause button switch 25B, stop button switch 25C, fast rewind button switch 25D, and fast forward button switch 25E.

When the user presses the DVD/CD start button switch 25A, an application program for playing back the contents stored in the medium such as the DVD or CD inserted to the optical disc drive 24 is automatically booted up. The playback/pause button switch 25B is a button switch used to issue an instruction to play back contents or temporarily stop playback of the contents stored in the medium such as the DVD or CD inserted to the optical disc drive 24. The stop button switch 25C is a button switch used to issue an instruction to stop playback of the contents stored in the medium such as the DVD or CD. The fast rewind button switch 25D is a button switch used to fast rewind the playback position of the contents. The fast forward button switch 25E is a button switch used to fast forward the playback position of the contents.

The hold switch 23 is a button switch used to inhibit the operations of the respective button switches of the input operation panel 25. When the hold switch 23 is ON, the operations of the respective button switches of the input operation panel 25 are disabled.

When the docking station 20 is connected to the computer 10 (hot docking), the docking station 20 is powered on by the computer 10. The computer 10 can use the docking station 20 as an external device.

As described above, the docking station 20 is driven by a power supply from the computer 10. Hence, the user can carry the docking station 20 with the computer 10, and use the docking station 20 connected to the computer 10 away from home.

In addition to a versatile main operating system, a dedicated sub operating system for playing back the audio/video data is installed in the computer 10.

When the user presses the power button switch 14, the main operating system is booted up. In the main operating system, the first DVD/CD playback application program starts when the user presses the DVD/CD start button switch 25A in a state wherein the docking station 20 is connected to the computer 10. The first DVD/CD playback application program is a program for playing back the contents stored in the medium such as the DVD or CD, and operates on the main operating system.

When the user presses the DVD/CD start button switch 25A of the docking station 20 in a state wherein the computer 10 is OFF and the docking station 20 is connected to the computer 10, the sub-operating system is booted up to execute the second DVD/CD playback application program. The second DVD/CD playback application program is a program for playing back the contents stored in the medium such as the DVD or CD, and operates on the sub operating system.

The sub-operating system has a function for, at least, executing the function of playing back the audio/video contents. Hence, the time required for the boot up process of the sub operating system is much shorter than that for the boot up process of the main operating system. Therefore, the user can immediately play back the audio/video contents merely by pressing the DVD/CD start button switch 25A while the docking station 20 is connected to the computer 10.

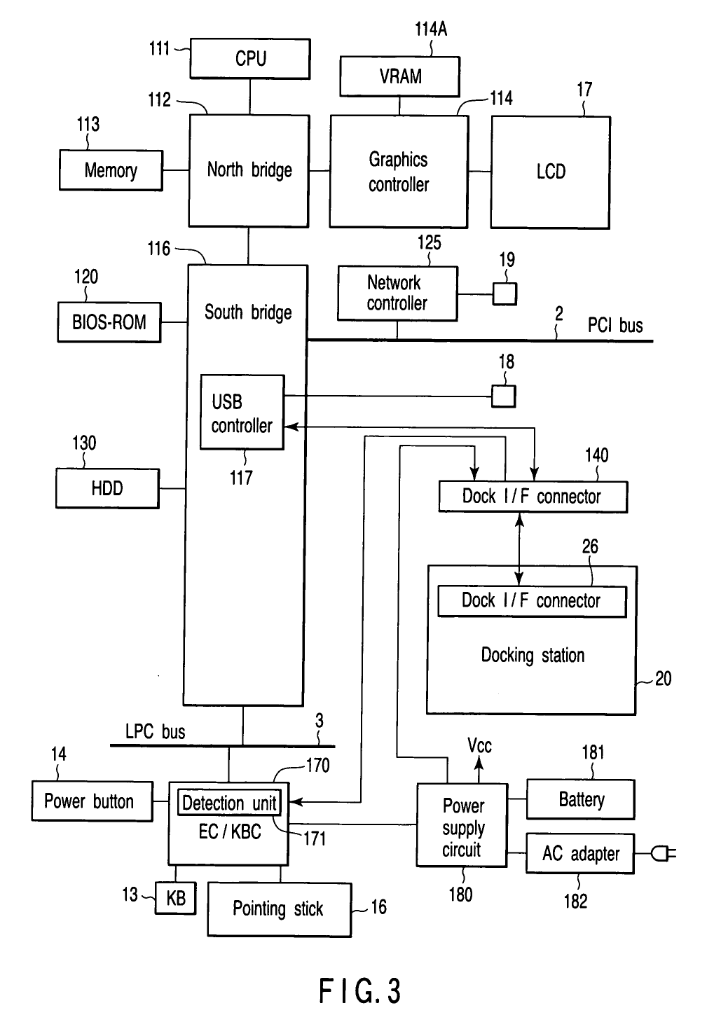

The system arrangement of the computer 10 will be described below with reference to FIG. 3.

The computer 10 comprises a CPU 111, a north bridge 112, a main memory 113, a graphics controller 114, the LCD 17, a south bridge 116, a BIOS-ROM, a network controller 125, a hard disc drive (HDD) 130, a docking interface (Dock I/F) connector 140, an embedded controller/keyboard controller (EC/KBC) IC 170, a power supply circuit 180, and the like.

The CPU 111 is a processor which controls the operations of respective components of the computer 10. The CPU 111 executes an operating system (main operating system or sub operating system) and various application programs which are loaded from, e.g., the HDD 130 onto the main memory 113. In this embodiment, assume that the operating system (main operating system or sub operating system) is stored in the HDD 130.

The CPU 111 also executes a system basic input output system (BIOS) stored in the BIOS-ROM 120. The system BIOS is a program for hardware control. The system BIOS has a function of executing the above described device removing process (undocking process) in collaboration with the currently executed operating system (main operating system or sub operating system).

The north bridge 112 is a bridge device that connects the local bus of the CPU 111 and the south bridge 116. The north bridge 112 also has a function of communicating with the graphics controller 114 via an accelerated graphics port (AGP) bus or the like. The north bridge 112 also incorporates a memory controller that controls the main memory 113.

The graphics controller 114 is a display controller which controls the LCD 17 used as the display monitor of the computer 10. The graphics controller 114 displays data written in a video memory (VRAM) 114A on the LCD 17, by the operating system (main operating system or sub operating system) or the application program.

The south bridge 116 incorporates an integrated drive electronics (IDE) controller which controls the HDD 130, and a USB controller 117 which controls the USB device. The south bridge 116 is connected to a peripheral component interconnect (PCI) bus 2 and a low pin count (LPC) bus 3.

To the PCI bus 2, the network controller 125 is connected. The network controller 125 executes communication with the external network device via the LAN cable connected to the LAN port 19.

The EC/KBC IC 170 is a 1-chip microcomputer on which an embedded controller for power supply management, and a keyboard controller that controls the keyboard (KB) 13 and pointing device 16 are integrated. The keyboard (KB) 13 and pointing device 16 function as input units.

The EC/KBC IC 170 has a function of turning on/off the power supply of the computer 10 in response to the user's operation of the power button switch 14 or DVD/CD start button switch 25A in collaboration with the power supply circuit 180. The EC/KBC IC 170 also has a detection unit 171 which detects operations of the button switches 25A to 25E arranged on the input operation panel 25, and operation of the undocking switch 21, in the docking station 20. When the detection unit 171 detects operation of the undocking switch 21, the above described removing process is executed.

The power supply circuit 180 generates a system power supply to be supplied to respective components of the computer 10 using an external power supply supplied via an AC adapter 182, or a battery 181. The power supply circuit 180 also generates operation power supply Vcc to be supplied to the docking station 20, under the control of the EC/KBC IC 170.

The computer 10 is connected to the docking station 20 via the docking interface connector 140. In this embodiment, as described above, the docking station 20 complies with the USB standard, and the optical disc drive 24 in the docking station 20 is controlled by the USB controller 117.

Each of the docking interface connectors 140 and 26 has about 50 pins. As these pins, some power supply pins for supplying an operation power supply voltage from the computer 10 to the docking station 20, some signal pins connected to a USB signal line group, and some signal pins used when the docking station 20 notifies the computer 10 of the state of the button switch group arranged on the docking station 20 are defined.

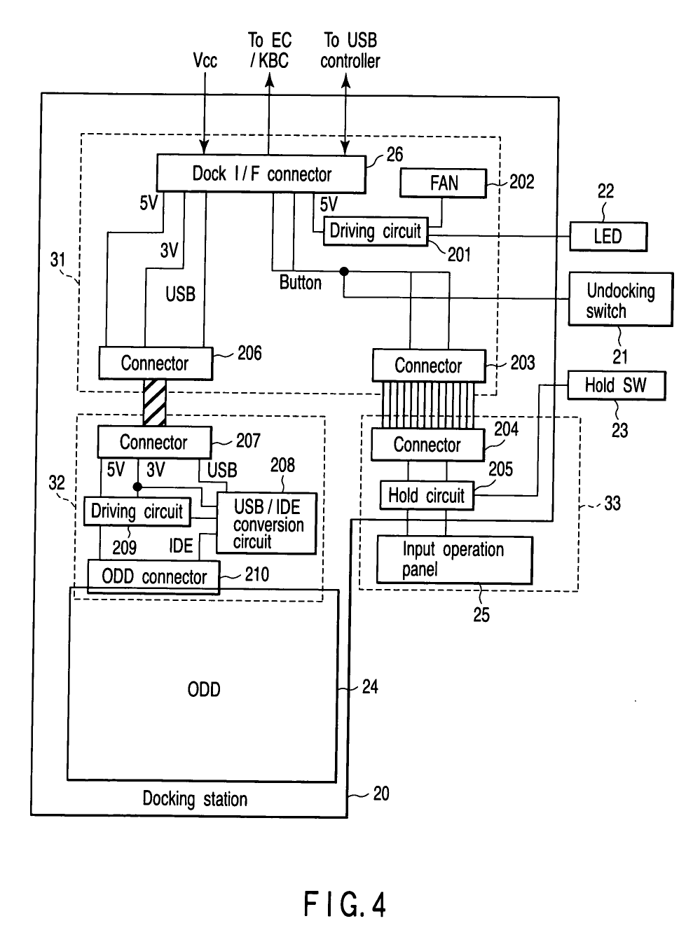

The system arrangement of the docking station 20 will be described next with reference to FIG. 4.

The docking station 20 incorporates three print circuit boards 31, 32, and 33.

The board 31 mounts the docking interface connector 26, a driving circuit 201, an air cooling fan (FAN) 202, and connectors 203 and 206. The docking interface connector 26 is connected to the driving circuit 201, and connectors 203 and 206 via lines on the board 31. The connector 203 is a connector for connecting the board 31 to the board 33 via a cable. The connector 206 is a connector for connecting the board 31 to the board 32 via a cable.

The driving circuit 201 is a circuit for driving the FAN 202 and the LED 22, and generates power supply voltages for driving the FAN 202 and the LED 22 using a power supply voltage supplied from the computer main body 11 via the docking interface connector 26.

The connector 203 receives the signal line group indicating the states of the five button switches of the input operation panel 25, from the board 33 via a cable. The signal line group is connected to the docking interface connector 26, as the button signal line together with the signal line indicating the state of the undocking switch 21. The button signal line is connected to the EC/KBC IC 170 via the docking interface connector 140 of the computer main body 11.

The connector 206 is connected to a connector 207 of the board 32 via a cable. As the cable between the connectors 206 and 207, some power supply lines and USB signal lines are defined.

The board 32 mounts the connector 207, a USB/IDE (USB to IDE) conversion circuit 208, a driving circuit 209, and an ODD connector 210. The connector 207 is connected to the USB/IDE conversion circuit 208, driving circuit 209, and ODD connector 210 via lines on the board 32. The driving circuit 209 generates power supply voltages to be supplied to the USB/IDE conversion circuit 208 and the optical disc drive (ODD) 24 via the ODD connector 210, using the power supply voltage supplied from the connector 207. The USB/IDE conversion circuit 208 has a function of converting the USB signal input via the connector 207 into the IDE signal, and a function of converting the IDE signal input from the ODD 24 via the ODD connector 210 into the USB signal.

The board 33 mounts a connector 204, a hold circuit 205, and the operation button switch group arranged on the input operation panel 25. When the hold switch (Hold SW) 23 is ON, the connector 204 is electrically separated from the operation button switch group arranged on the input operation panel 25 by the hold circuit 205.

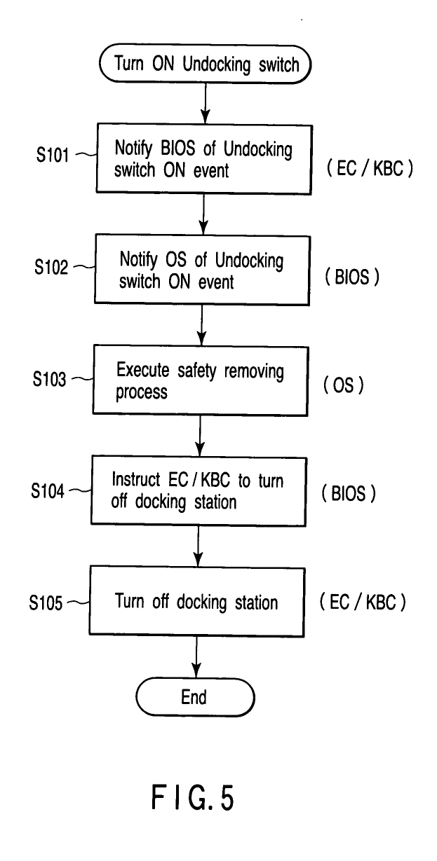

A removing process procedure executed in response to the operation of the undocking switch 21 will be described next with reference to the flowchart of FIG. 5.

When the user presses the undocking switch 21, the EC/KBC IC 170 receives a button signal indicating that the undocking switch 21 is turned on, via the docking interface connector 26.

Upon reception of the button signal, the EC/KBC IC 170 detects that the user has pressed the undocking switch 21. The EC/KBC IC 170 sends an interruption signal to the CPU 111 to notify the system BIOS of an event (undocking switch ON event) indicating that the undocking switch 21 has been operated, i.e., that a removing request of the docking station 20 has been issued (block S101).

The system BIOS notifies the currently executed operating system of the event (undocking switch ON event) indicating that the removing request of the docking station 20 has been issued (block S102). The operating system executes the device removing process (safety removing process) for setting the system of the computer 10 to a state wherein the external device (docking station 20) designated by the undocking switch ON event can be removed from the computer main body 11 (block S103).

This safety removing process is a process of stopping a service for accessing the external device (docking station 20) designated by the undocking switch ON event. In the safety removing process, it is determined whether the external device (docking station 20) designated by the undocking switch ON event is currently accessed. If the external device (docking station 20) is currently accessed, the safety removing process is interrupted. In this case, the operating system displays, on the LCD 17, a message indicating that the external device (docking station 20) cannot be removed.

Alternatively, if the external device (docking station 20) is not currently accessed, the safety removing process is successfully performed, and the service for accessing the external device (docking station 20) is stopped. With this operation, the external device (docking station 20) is removed from the hardware resources of the computer 10. In this case, the operating system displays, on the LCD 17, a message indicating that the external device (docking station 20) can be safely removed, and notifies the system BIOS that the safety removing process has been successively performed.

The system BIOS instructs the EC/KBC IC 170 to turn off the power supply of the external device (docking station 20), i.e., to stop power supply to the external device (docking station 20) (block S104). The EC/KBC IC 170 controls the power supply circuit 180 to stop power supply to the docking station 20 (block S105). With this operation, the power supply of the external device (docking station 20) is turned off, and the power supply of the LED 22 is turned off.

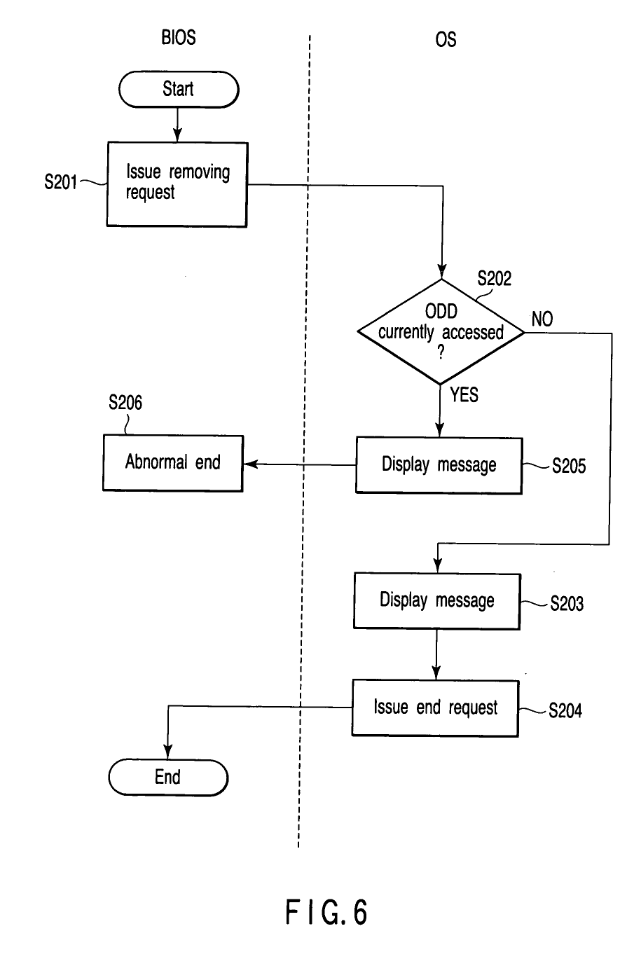

The first example of the safety removing process will be described next with reference to the flowchart of FIG. 6.

Upon reception of the undocking switch ON event from the EC/KBC IC 170, the system BIOS requests the currently executed operating system to execute the removing process of the external device (docking station 20) designated by the undocking switch ON event (block S201).

The operating system determines whether the docking station 20 is currently accessed, i.e., whether the ODD 24 is currently accessed (block S202). In block S202, the operating system determines whether data is currently read out from or written in the ODD 24.

If the ODD 24 is not currently accessed (NO in block S202), the operating system stops the service for accessing the docking station 20, and displays, on the LCD 17, the message indicating that the docking station 20 can be safely removed from the computer 10 (block S203). The operating system then notifies the system BIOS of a response (end request) indicating that the removing process has been successively performed (block S204). The system BIOS controls the power supply circuit 180 to stop power supply to the docking station 20. With this operation, a docking clamp between the computer 10 and the docking station 20 is released.

Alternatively, when it is determined that the access process is currently executed (YES in block S202), the operating system displays, on the LCD 17, a message indicating that the docking station 20 cannot be removed from the computer 10, and notifies the system BIOS that the removing process has failed (block S205). At this time, the removing process of the system BIOS abnormally ends (block S206). Note that power is kept supplied to the docking station 20.

As described above, during a period wherein the ODD 24 is accessed, the removing process cannot be performed. Hence, for example, during a period wherein data is written in a CD-Recordable (CD-R) inserted to the ODD 24 in accordance with a writing application by the computer 10, the docking station 20 cannot be removed from the computer 10.

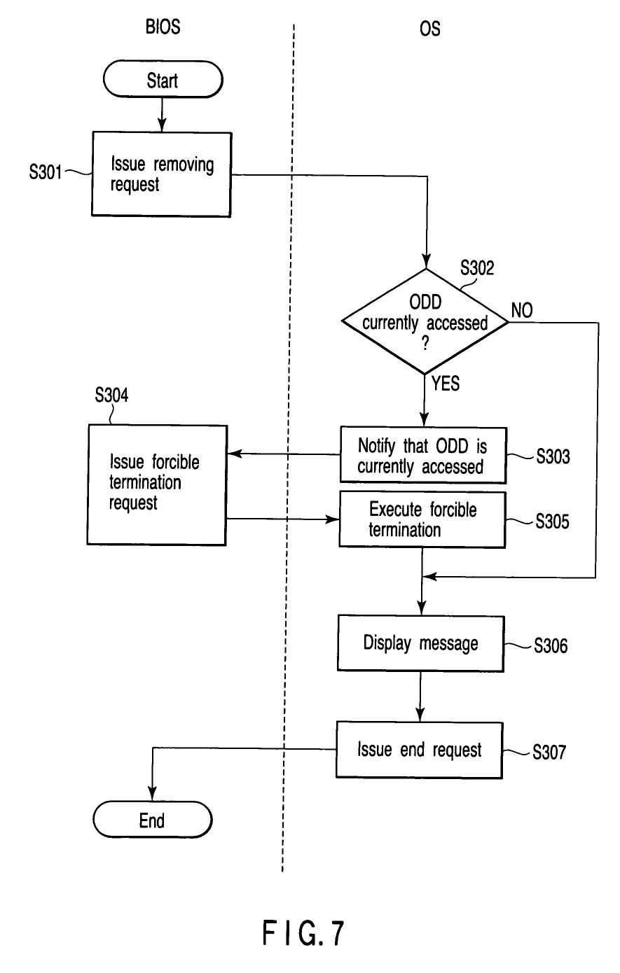

The second example of the safety removing process will be described next with reference to the flowchart of FIG. 7. In the second example of the safety removing process, the docking station 20 can be safely removed from the computer 10 even during a period wherein the ODD 24 is accessed.

Upon reception of the undocking switch ON event from the EC/KBC IC 170, the system BIOS requests the currently executed operating system to execute the removing process of the external device (docking station 20) designated by the undocking switch ON event (block S301).

The operating system determines whether the docking station 20 is currently accessed, i.e., whether the ODD 24 is currently accessed (block S302).

When the ODD 24 is currently accessed (YES in block S302), the operating system notifies the system BIOS that the ODD 24 is currently accessed (block S303). Upon reception of this notification, the system BIOS notifies the operating system of the request to forcibly terminate the access process (block S304). In block S304, the system BIOS requests the operating system to stop (forcibly terminate) execution of software which accesses the ODD 24.

The operating system forcibly terminates the software (application program, device driver, or the like) which accesses the ODD 24 (block S305). After that, the operating system stops the service for accessing the ODD 24, and displays, on the LCD 17, the message indicating that the docking station 20 can be removed from the computer 10 (block S306). The operating system then notifies the system BIOS of a response (end request) indicating that the removing process has been successively performed (block S307). The system BIOS controls the power supply circuit 180 to stop power supply to the docking station 20. With this operation, a docking clamp between the computer 10 and the docking station 20 is released.

When the ODD 24 is not currently accessed (NO in block S302), the process of the operating system shifts to the operation in block S306.

As described above, in the second example, regardless of whether the computer 10 executes an access process such as read/write processes for the ODD 24, the docking clamp between the computer 10 and the docking station 20 is immediately released.

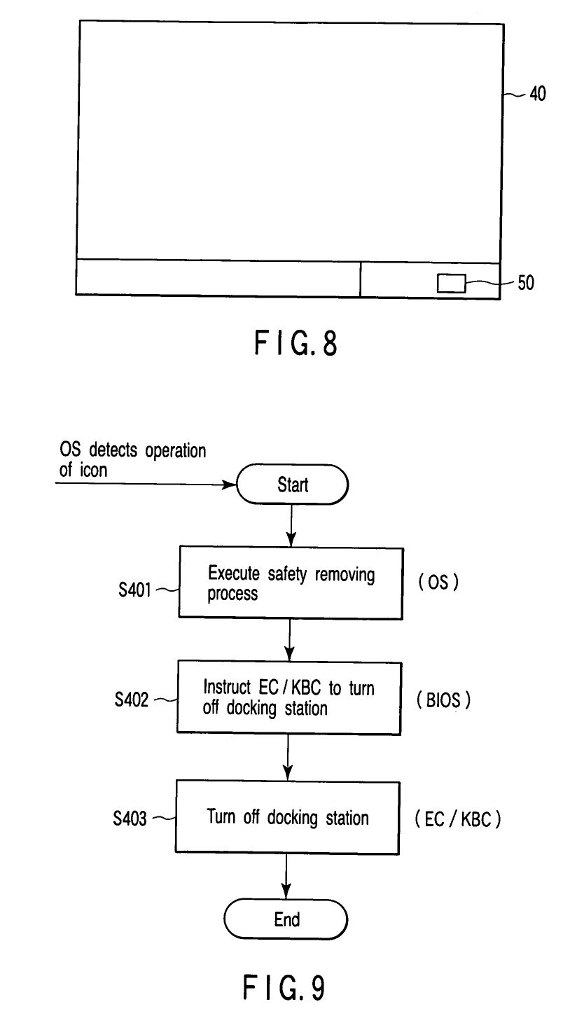

FIG. 8 shows an example of the display screen on the LCD 17 in the power on state of the computer 10. A removing icon 50 is displayed in, e.g., the lower right corner of a display screen 40. The above-described removing process is also executed when the user clicks the removing icon 50 via an input unit such as the keyboard 13 or the pointing device 16.

The removing process to be executed when the user operates the removing icon 50 on the display screen 40 will be described next with reference to the flowchart of FIG. 9. When the user operates the removing icon 50, the operating system executes the safety removing process (block S401). In block S401, the operating system displays the window which indicates the external device list, on the LCD 17. This list includes, e.g., the list of the USB devices connected to the computer 10. When the docking station 20 (ODD 24) is selected from the external device list in accordance with the user's operation on the input unit, the operating system executes the device removing process for setting the system of the computer 10 to a state wherein the docking station 20 can be removed from the computer main body 11. When the safety removing process is successively performed, the operating system displays, on the LCD 17, a message indicating that the docking station 20 can be safely removed, and notifies the system BIOS that the safety removing process has been successively performed.

The system BIOS instructs the EC/KBC 170 to turn off the power supply of the docking station 20 (block S402). The EC/KBC 170 controls the power supply circuit 180 to stop supplying power supply to the docking station 20 (block S403). With this operation, the power supply of the docking station 20 is turned off.

In block S401, the second example of the removing process described with reference to FIG. 7 can also be used.

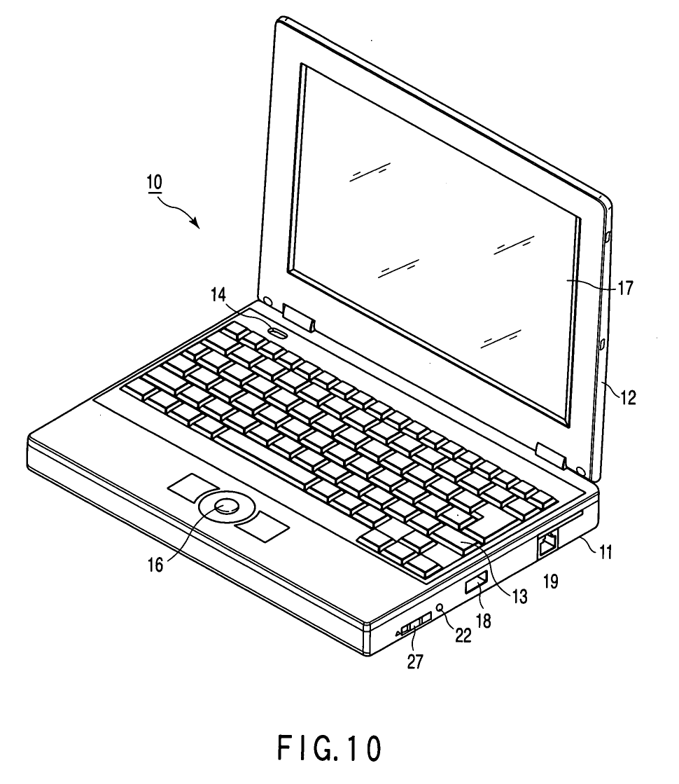

FIG. 10 shows another embodiment in which an LED 22 and an undocking switch 27 having the same functions of an undocking switch 21 are arranged on the side wall of a computer main body 11.

Even when the undocking switch 27 is arranged on the computer main body 11, the above described removing process for safely removing a docking station 20 is executed upon operation of the undocking switch 27.

As described above, in this embodiment, the removing process for safely removing an external device is automatically executed in response to the operation of the switch arranged on this external device connected to a computer 10. With this operation, the user can easily remove the external device from the computer 10 merely by operating the switch of the external device. In this case, since no operation of selecting, from the menu window, the device to be removed is required, the user can remove the external device quickly by a simple operation. Especially, when a technique of forcibly terminating the execution of software which accesses the external device is applied, the external device can be safely removed from the computer 10 even while the external device is being accessed.

In this embodiment, a docking station is described as an example of the external device. However, various devices, such as a storage device capable of storing data, which can be connected to the computer 10 via a cable or connector can also be used as the external device.

In this embodiment, the drive unit mounted on the docking station 20 is only the ODD 24. However, the docking station 20 may mount a plurality of drive units. In this case, a plurality of undocking switches may be arranged in correspondence with the respective drive units. In this arrangement, the removing process can be executed only for the drive unit corresponding to the operated undocking switch of the plurality of undocking switches.

In this embodiment, the ODD 24 is connected to the computer 10 via the USB interface. However, various interfaces, such as PCI Express, Serial Advanced Technology Attachment (SATA), Institute of Electrical and Electronics Engineers (IEEE) 1394, capable of a hot plug/hot unplug process can be used between the computer 10 and the external device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a main body to which an external device is connectable;
a detection unit configured to detect that a switch arranged on the external device is operated; and
a control unit configured to execute a device removing process for setting a system of the main body to a state wherein the external device can be removed from the main body, when the detection unit detects that the switch is operated.

2. The information processing apparatus according to claim 1, wherein the device removing process includes a process of determining whether the external device is accessed; and a process of stopping execution of software which accesses the external device when the external device is accessed.

3. The information processing apparatus according to claim 1, further comprising a display unit; and
the control unit includes a display unit which displays a message indicating that the external deice can be removed from the main body, when the device removing process is successively performed.

4. The information processing apparatus according to claim 1, wherein the external device includes a storage device which stores data.

5. The information processing apparatus according to claim 1, wherein the control unit includes a unit which turns off a power supply of the external device when it is determined that the external device can be removed from the main body.

6. The information processing apparatus according to claim 1, further comprising an input unit configured to input a removing request to remove the external device from the main body; and
the control unit executes the device removing process when the detection unit detects that the switch is operated, or when the input unit inputs the removing request.

7. The information processing apparatus according to claim 1, wherein the external device serves as an expansion unit which is used to expand a function of the main body.

8. An operation control method for controlling an operation of an information processing apparatus including a main body to which an external device is connectable, comprising:
detecting that a switch arranged on the external device is operated; and
executing a device removing process for setting a system of the main body to a state wherein the external device can be removed from the main body, when an operation of the switch is detected by the detecting.

9. The operation control method according to claim 8, wherein the executing includes execution of a process of determining whether the external device is accessed, and execution of a process of stopping execution of software which accesses the external device when the external device is accessed.

10. The operation control method according to claim 8, further comprising displaying, on a display unit of the information processing apparatus, a message indicating that the external deice can be removed from the main body, when the device removing process is successively performed.

11. The operation control method according to claim 8, wherein the external device includes a storage device which stores data.

12. The operation control method according to claim 8, further comprising turning off a power supply of the external device when it is determined that the external device can be removed from the main body.

13. The operation control method according to claim 8, further comprising issuing a removing request to remove the external device from the main body in response to an operation of an input unit arranged in the information processing apparatus; and
the removing process is executed when an operation of the switch is detected by the detection, or when a removing request is issued in the step of issuing the removing request.
